(19) United States
(12) Patent Application Publication
(10) Pub. No.: US 2013/0136854 A1
(43) Pub. Date: May 30, 2013

(54) MOLDING CORE AND METHOD OF MANUFACTURING THE SAME

(71) Applicant: Li-Ying WANG HE, Tu-Cheng (TW)

(72) Inventor: Li-Ying WANG HE, Tu-Cheng (TW)

(73) Assignee: HON HAI PRECISION INDUSTRY CO., LTD., Tu-Cheng (TW)

(21) Appl. No.: 13/550,786

(22) Filed: Jul. 17, 2012

(30) Foreign Application Priority Data
Nov. 25, 2011 (TW) 100143240

(51) Int. Cl. B29C 33/56

(52) U.S. Cl. 427/133; 249/114.1

(57) ABSTRACT

A molding core includes a main body and a protective layer. The main body includes a molding surface and a rear surface opposite to the molding surface. The protective layer is formed on the rear surface of the main body. The present disclosure also discloses a method of manufacturing the molding core.

### BACKGROUND

1. Technical Field

The present disclosure generally relates to molding cores, and particularly, to a molding core for molding optical components and a method of manufacturing the same.

2. Description of the Related Art

Molds are widely used in injection molding process, especially for molding optical components, such as a light guide plate. A mold generally has a molding core, and the molding core includes a molding surface and a rear surface opposite to the molding surface. The molding surface is covered with a layer of diamond-like carbon protective film to prevent the molding surface defects from transferring to the molded optical components. The rear surface is not covered with any particular material layer, because the rear surface does not need to be contacted with the optical components. However, in the injection molding process, the injection pressure applied on the molding core is high, and thus the molding core may collide with other parts of the mold. As a result, the rear surface of the molding core is easily scratched or cracked in the mold; therefore, the molding core may shake in the mold during the injection molding process, resulting in a decreased manufacturing precision of the optical components.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a molding core.

FIG. 2 is a flowchart of a method of manufacturing the molding core of FIG. 1.

### DETAILED DESCRIPTION

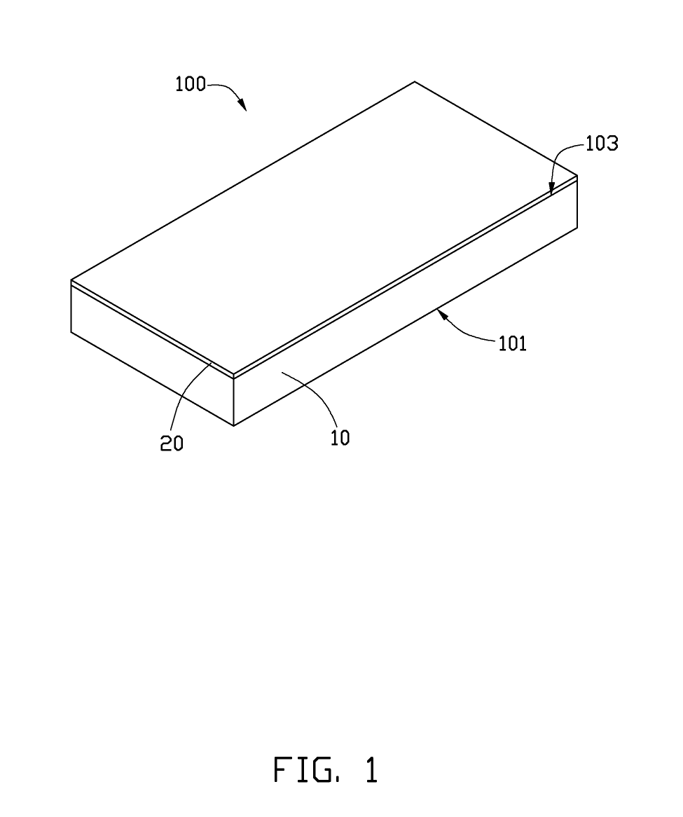

Referring to FIG. 1, an embodiment of a molding core 100 includes a main body 10 and a protective layer 20. The main body 10 includes a molding surface 101 and a rear surface 103 opposite to the molding surface 101. The protective layer 20 is formed on the rear surface 103.

The main body 10 can be made of ceramic, cermet, or cemented carbide. The cemented carbide includes silicon carbide (SiC), silicon (Si), silicon nitride (Si₃N₄), Zirconia (ZrO₂), alumina oxide (Al₂O₃), titanium nitride (TiN), titanium dioxide (TiO₂), titanium carbide (TiC), boron carbide (B₄C), tungsten carbide (WC), tungsten (W), and cobalt tungsten carbide (WC—Co). In the illustrated embodiment, the main body 10 is made of cemented carbide.

The protective layer 20 is made of flexible organic polymer materials, such as resin or rubber. The resin may be hydroxy straight-chain polyester resin or polyurethane elastomer modified polyester resin. The rubber may be natural rubber or synthetic rubber. The synthetic rubber is selected from a group consisting of styrene butadiene rubber, butadiene rubber, and silicone. The silicone is selected from a group consisting of vulcanizing silicone rubber, methylene-bis-phenyl-cured silicone, poly-β-nitrile ethyl methyl siloxane, and dimethyl polysiloxane (silicone). In the illustrated embodiment, the protective layer 20 is made of silicone, especially poly-dimethyl siloxane or dimethyl siloxane silicone. The protective layer 20 is evenly formed on the rear surface 103 of the main body 10 by a roller coating method or an injection molding method.

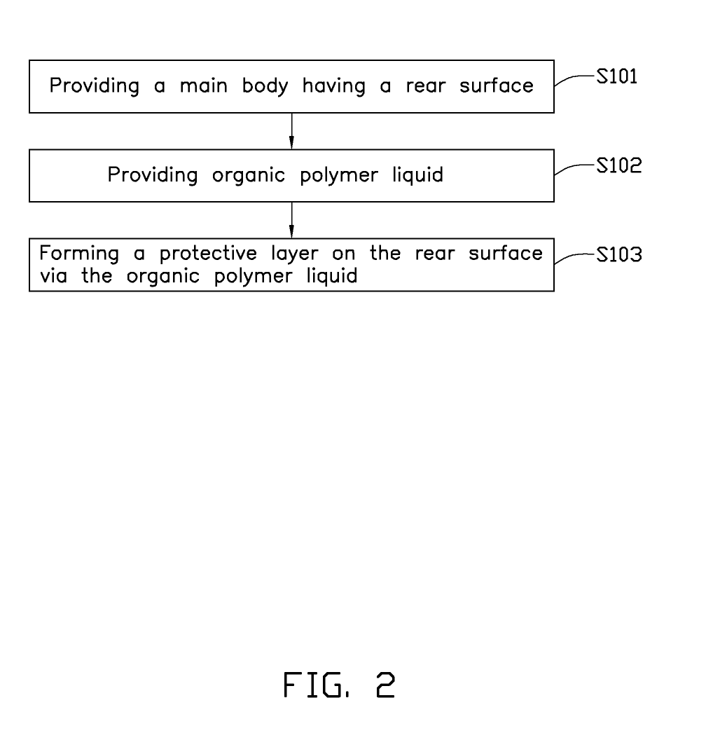

Referring to FIG. 2, a method of manufacturing the molding core 100 is described as follow.

In a step S101, a main body 10 having a rear surface 103 is provided. In the illustrated embodiment, the main body 10 is made of cemented carbide. The main body 10 is cleaned to remove oil and oxides from the rear surface 103. The cleaning method may be an ultrasonic vibration cleaning method or a sputter cleaning method.

In a step S102, an organic polymer liquid is provided. The organic polymer liquid may be a resin or a rubber under a liquid solution. The resin may be hydroxy straight-chain polyester resin or polyurethane elastomer modified polyester resin. The rubber may be natural rubber or synthetic rubber. The synthetic rubber is selected from a group consisting of styrene butadiene rubber, butadiene rubber, and silicone. The silicone is selected from a group consisting of vulcanizing silicone rubber, methylene-bis-phenyl-cured silicone, poly-β-nitrile ethyl methyl siloxane, and dimethyl siloxane silicone. In the illustrated embodiment, the protective layer 20 is made of silicone, specifically dimethyl siloxane silicone.

In a step S103, a protective layer 20 is formed on the rear surface 103 of the main body 10 via the organic polymer liquid. In the illustrated embodiment, the organic polymer liquid is evenly coated on the rear surface 103 by the roller coating method. The organic polymer liquid is dispersed on the rear surface 103 of the main body 10, and then the organic polymer liquid is evenly coated on the rear surface 103 by rotating a coating roller (not shown) on the rear surface 103. The main body 10 is put into an oven (not shown) for curing, so that the protective layer 20 is formed on the rear surface 103. The temperature of the oven is maintained at lower than 60° C.

In an alternative embodiment, a liquid curing agent may be added into the organic polymer liquid in the step S102, thereby reducing a curing time of the organic polymer liquid in the step S103.

Because the molding core 100 has the protective layer 20 on the rear surface 103 of the main body 10, the protective layer 20 can cushion the injection pressure applied on the molding core 100. That is, the rear surface 103 of the molding core 100 is prevented from being scratched or cracked, such that the molding core 100 can sustain a high manufacturing precision.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A molding core, comprising:
a main body comprising a molding surface and a rear surface opposite to the molding surface; and
a protective layer formed on the rear surface of the main body.

2. The molding core of claim 1, wherein the main body is made of a cemented carbide comprising silicon carbide, silicon, silicon nitride, Zirconia, alumina oxide, titanium nitride, titanium dioxide, titanium carbide, boron carbide, tungsten carbide, tungsten, and cobalt tungsten carbide.

3. The molding core of claim 1, wherein the protective layer is made of one or more flexible organic polymer materials.

4. The molding core of claim 3, wherein the protective layer is made of silicone.

5. The molding core of claim 4, wherein the silicone is dimethyl siloxane silicone.

6. A method of manufacturing a molding mold, comprising:
providing a main body having a rear surface;
providing an organic polymer liquid; and
forming a protective layer on the rear surface via the organic polymer liquid.

7. The method of claim 6, wherein before forming the protective layer, the main body is cleaned by ultrasonic vibration cleaning to remove oil and oxides from the rear surface.

8. The method of claim 6, wherein a liquid curing agent is added into the organic polymer liquid.

9. The method of claim 6, wherein the main body is made of a cemented carbide comprising silicon carbide, silicon, silicon nitride, Zirconia, alumina oxide, titanium nitride, titanium dioxide, titanium carbide, boron carbide, tungsten carbide, tungsten, and cobalt tungsten carbide.

10. The method of claim 9, wherein the protective layer is made of silicone.

11. The method of claim 10, wherein the silicone is dimethyl siloxane silicone.
